(19) United States
(12) Patent Application Publication
(10) Pub. No.: US 2005/0095489 A1
(43) Pub. Date: May 5, 2005

(54) Metallic separator for fuel cell and manufacturing method therefor

(76) Inventors: Makoto Tsuji, Wako-shi (JP); Masajiro Inoue, Wako-shi (JP); Masao Utsunomiya, Wako-shi (JP); Teruyuki Otani, Wako-shi (JP); Takashi Kuwayama, Wako-shi (JP); Takahiro Takai, Wako-shi (JP)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/942,628

(22) Filed: Sep. 28, 2004

(30) Foreign Application Priority Data
Sep. 29, 2003 (JP) 2003-338390

(51) Int. Cl. H01M 8/02; B32B 15/01; B05D 5/12; B32B 15/20

(52) U.S. Cl. 429/34; 428/674; 428/673; 428/680; 428/646; 427/115

(57) ABSTRACT

A metallic separator for a fuel cell (and a manufacturing method therefore) can reduce damage to an electrode assembly, open up the maximum capacity of the reducing effect of contact resistance due to coating of gold by gold plating or the like, and reduce consumption of gold to lower the cost. Conductive inclusions are exposed at the surface with corrosion resistance, and at least one kind of metal or an alloy thereof selected from silver, copper, nickel, and tin is precipitated on the exposed conductive inclusions. From the viewpoint of reducing contact resistance, the conductive inclusions preferably protrude from the separator surface.

### BACKGROUND OF THE INVENTION

1. Field of the Invention

The present invention relates to a metallic separator for a solid high polymer type fuel cell, and relates to a manufacturing method therefor.

2. Description of the Related Art

A solid high polymer type fuel cell is formed as a fuel cell stack by laminating a plurality of units, one unit being a laminated body having separators laminated on both sides of a flat electrode assembly (MEA: Membrane Electrode Assembly). The electrode assembly has a three-layer structure having an electrolyte membrane made of ion exchange resin or the like enclosed between a pair of gas diffusion electrodes composing a positive electrode (cathode) and a negative electrode (anode). The gas diffusion electrodes have gas diffusion layers formed at the outside of an electrode catalyst layer contacting with the electrode membrane. The separators are laminated so as to contact with the gas diffusion electrodes of the electrode assembly, and a gas passage and a refrigerant passage are formed for circulating gas between the gas diffusion electrodes and the separators. In such a fuel cell, for example, by passing hydrogen gas as a fuel in the gas passage facing gas diffusion electrode on the negative electrode side and passing oxidizing gas such as oxygen or air in the gas passage facing gas diffusion electrode on the positive electrode side, an electrochemical reaction occurs, whereby electricity is generated.

The separator is required to have functions of supplying electrons generated by catalytic reaction of hydrogen gas at the negative electrode side to an external circuit, and also supplying electrons from the external circuit to the positive electrode side. Accordingly, the separator is formed of a conductive material made of a graphite material or metal material, and in particular, the metal material is believed to be more advantageous because it is superior in mechanical strength and it can be formed into thin plates, thereby obtaining lightweight and compact plates. A metallic separator is formed by pressing a thin plate of corrosion resistant metal material of stainless steel, titanium alloy or the like, and forming it into a corrugated section.

In the case of a separator made of stainless steel, the contact resistance with the electrode assembly is larger than that of a graphite separator. Increase in contact resistance leads to a decrease in power generation performance, and to reduce the contact resistance, for example, Japanese Laid-open Patent Application No. 2003-187829 (section [0010]) (patent reference 1) discloses a technology of protruding a conductive intermetallic compound such as boride (M₂B) on the surface of a stainless steel separator, thereby reducing the contact resistance with the electrode assembly.

Generally, a solid high polymer type fuel cell is exposed to high temperatures of 70° C. or more when generating power, and is also exposed to high humidity conditions as humidified fuel gas and air are supplied inside and moisture is formed by reaction at the electrodes when generating power. As a result, the electrode assembly is expanded and swollen, and the surface pressure at the electrode assembly and separator is increased. In contrast, when power generation is stopped, the temperature and humidity of the electrode assembly decline, whereby the surface pressure of the electrode assembly and separator is decreased. Thus, by the cycles of power generation and stopping, repetitive stresses occur between the electrode assembly and separator.

In the technology disclosed in the patent reference 1, the conductive intermetallic compound protrudes at the separator surface. Therefore, by the repetitive stresses occurring between the electrode assembly and separator, the surface of the electrode assembly is damaged, whereby the contact resistance between the separator and electrode assembly is increased, resulting in degrading the current collecting function of the separator.

It has been attempted to coat the surface of separator made of stainless steel with a highly conductive metal such as gold. However, there is a problem in that the gold consumption is too great, and it is expensive. For gold plating, usually, a treatment for a substrate is performed by nickel plating in order to enhance adhesion with stainless steel. However if the gold plating has defects such as pin holes, the nickel which is a component in the treatment for substrate may elute. Elution of nickel lowers the performance, for example, the ion exchange capacity of the electrolyte membrane, and further leads to other problems such as peeling of gold plating or increase in contact resistance. To avoid such problems, when gold plating is directly applied without a treatment for substrate, the adhesion of gold plating decreases, whereby peeling occurs, and hence the contact resistance is also increased.

### SUMMARY OF THE INVENTION

It is therefore an object of the invention to provide a metallic separator for a fuel cell and to provide a manufacturing method therefor which can provide superior reducing effect of contact resistance by plating, minimizing the consumption of plating metal and reducing cost, and suppressing damage to the electrode assembly by a conductive intermetallic compound protruding from the surface.

In a metallic separator for a fuel cell in a first aspect of the invention, conductive inclusions are exposed on a surface with corrosion resistance, and at least one kind of metal or an alloy thereof selected from silver, copper, nickel, and tin is precipitated selectively on the exposed conductive inclusions.

In a metallic separator for a fuel cell in a second aspect of the invention, conductive inclusions are exposed on a surface with corrosion resistance, and at least one kind of platinum and palladium is selectively precipitated on the exposed conductive inclusions.

In a metallic separator for a fuel cell in a third aspect of the invention, conductive inclusions are exposed on a surface with corrosion resistance, and at least one kind of metal or an alloy thereof selected from silver, copper, nickel, and tin, and at least one kind of platinum and palladium are selectively precipitated on the exposed conductive inclusions.

In the metallic separator for a fuel cell having such a structure, the conductive inclusions form conductive paths, whereby the inclusions play a role in decreasing the contact resistance. Even if conductive inclusions with high hardness are protruding from the separator surface, since the surface is coated with a softer metal, the metal functions as a buffer material for the electrode assembly which is a facing member, and damage in surfaces of the electrode assembly is reduced. In the metallic separator for a fuel cell of the invention, the metal is deposed only on the conductive inclusions exposed on the separator surface, the consumption of metal is low, whereby the cost can be reduced. In the metallic separator for a fuel cell in the first aspect of the invention, since a base metal is precipitated, the cost can be substantially reduced. Further, since no oxide film is formed on the surface of the conductive inclusions, the metal adhesion is very high, whereby peeling of metal is suppressed, and the contact resistance is further reduced.

In the metallic separator for a fuel cell in the second aspect of the invention, since at least one kind of platinum and palladium is precipitated, the portion exposed to the gas passage which is not contacting the electrode assembly exhibits a catalytic function. That is, platinum or other catalyst is contained in the negative electrode catalyst layer of the electrode assembly, and by this catalyst, the fuel gas such as hydrogen gas is decomposed into protons (H⁺) and electrons. Therefore, by depositing platinum or the like in the separator, the reaction takes place before the fuel gas contacts with the negative electrode layer, so that the catalyst efficiency may be enhanced. In the metallic separator for a fuel cell in the third aspect of the invention, since a base metal or an alloy thereof and at least one kind of platinum and palladium are precipitated, the manufacturing cost is substantially reduced, and the catalyst function is enhanced.

The invention is not limited to a structure in which conductive inclusions protrude from the separator surface, and the invention includes a structure in which the inclusions are exposed at the separator surface without protruding. When the conductive inclusions protrude, the rate of conductive inclusions contacting with the electrode assembly is increased, whereby the contact resistance is further decreased. During operation of the fuel cell, the separator may be exposed to a corrosive environment of pH 3 or less due to ions being eluted from the electrode assembly, etc. Therefore, as a metal alloy to be precipitated on the conductive inclusions, Ni—B alloy, Ni—P alloy, or other amorphous metal having a high corrosion resistance may be effective, although the conductivity may be slightly reduced.

A first manufacturing method for a metallic separator for a fuel cell of the invention is a method for preferably manufacturing the separator of the invention. In the first manufacturing method, a material plate in which conductive inclusions are exposed from a surface with corrosion resistance is prepared. Then, a surface of the plate is directly plated with at least one kind of metal or an alloy thereof selected from silver, copper, nickel and tin, or at least one kind of platinum and palladium, without a treatment for a substrate.

A second manufacturing method for a metallic separator for a fuel cell of the invention is also a method for preferably manufacturing the separator of the invention. In the second manufacturing method, a material plate in which conductive inclusions are exposed from a surface with corrosion resistance is prepared. Then, a surface of the plate is directly plated with at least one kind of metal or an alloy thereof selected from silver, copper, nickel and tin, and at least one kind of platinum and palladium, without a treatment for a substrate.

According to the invention, by directly plating the surface of material plate with metal without a treatment for substrate, if there are pin holes and other defects in the metal plating, substrate components are not eluted. Therefore, metal plating does not peel, and a low contact resistance is assured.

As the metal material of the invention, stainless steel plate can be preferably used, the plate having conductive inclusions which forms conductive paths and which is dispersed in a metal structure. Specifically, the stainless steel plate having the following composition is preferably used. That is, C: 0.15 wt % or less, Si: 0.01 to 1.5 wt %, Mn: 0.01 to 2.5 wt %, P: 0.035 wt % or less, S: 0.01 wt % or less, Al: 0.001 to 0.2 wt %, N: 0.3 wt % or less, Cu: 0 to 3 wt %, Ni: 7 to 50 wt %, Cr: 17 to 30 wt %, Mo: 0 to 7 wt %, and balance of Fe, B and inevitable impurities, and Cr, Mo and B satisfy the following formula.
Cr (wt %)+3×Mo (wt %)−2.5×B (wt %)≧17
By using this stainless steel plate, B is precipitated on the surface as M₂B and MB type boride, and M₂₃(C, B)₆ type boride, and these borides are conductive inclusions.

According to the invention, conductive inclusions are exposed on the surface with corrosion resistance, and metal is precipitated selectively on the exposed conductive inclusions, and therefore damage in the electrode assembly is suppressed, the reducing effect of contact resistance by metal can be opened up to the full extent, and the metal consumption is reduced and the cost can be reduced.

### BRIEF DESCRIPTION OF THE DRAWINGS

FIG. 1 is a photograph of a separator manufactured in a preferred embodiment of the invention.

FIG. 2 is an SEM image of a separator in a preferred embodiment 1 of the invention.

FIG. 3 is an SEM image of a separator in a preferred embodiment 2 of the invention.

FIG. 4 is an SEM image of a separator in a preferred embodiment 3 of the invention.

FIG. 5 is an SEM image of a separator in a preferred embodiment 4 of the invention.

FIG. 6 is an SEM image of a separator in a preferred embodiment 5 of the invention.

FIG. 7 is an SEM image of a separator in a preferred embodiment 6 of the invention.

FIG. 8 is a graph showing the relationship of metal amount per unit area and contact resistance of separators in preferred embodiment 1 and comparative example 2.

FIG. 9 is a graph showing the relationship of metal amount per unit area and contact resistance of separators in preferred embodiment 2 and comparative example 2.

FIG. 10 is a graph showing the relationship of metal amount per unit area and contact resistance of separators in preferred embodiment 3 and comparative example 2.

FIG. 11 is a graph showing the relationship of metal amount per unit area and contact resistance of separators in preferred embodiment 4 and comparative example 2.

FIG. 12 is a graph showing the relationship of metal amount per unit area and contact resistance of separators in preferred embodiment 5 and comparative example 2.

FIG. 13 is a graph showing the relationship of metal amount per unit area and contact resistance of separators in preferred embodiment 6 and comparative example 2.

FIG. 14 is a graph showing the relationship of current value and cell voltage in a fuel cell in the case of using separators of preferred embodiment 5 and comparative examples 1 and 2.

FIG. 15 is a graph showing the relationship of current value and cell voltage in a fuel cell in the case of using separators of a preferred embodiment 6 and comparative examples 1 and 2.

### EXAMPLES

Preferred embodiments of the invention are described below.

A. Manufacture of Separator

### Preferred Embodiment 1

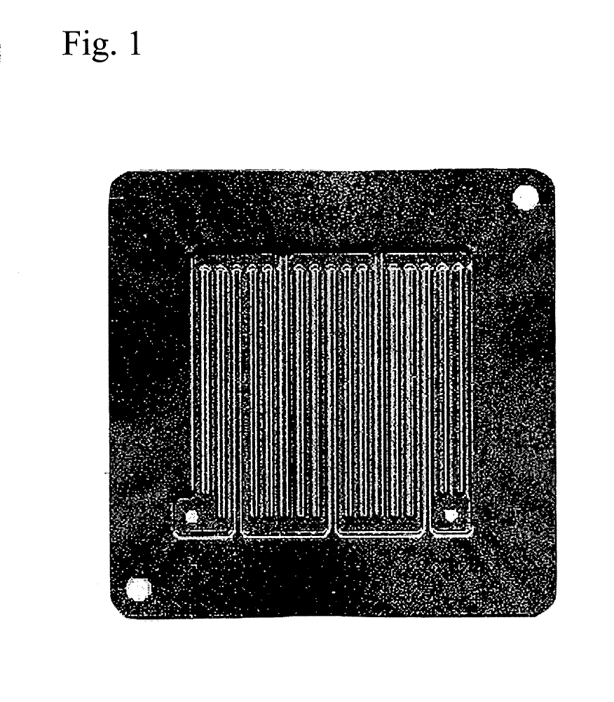

An austenitic stainless steel plate having the composition shown in Table 1 was rolled to a thickness of 0.2 mm, and a necessary number of square sheets of 100 mm×100 mm were cut out from the rolled steel. These thin sheets were press-formed, and a material plate for a separator as shown in FIG. 1 was obtained. This material plate has a power generating part in corrugated-section in the center, and has a flat edge in the periphery of the power generating part. In this material plate, B in component is precipitated in the metal structure as M₂B and MB type boride and M₂₃(C,B)₆ type boride, and these borides are conductive inclusions forming conductive paths on the separator surface.

TABLE 1

(wt %)

| C | Si | Mn | P | S | Cu | Ni | Cr | Mo | Nb | Ti | Al | N | B |
|---|---|---|---|---|---|---|---|---|---|---|---|---|---|
| 0.073 | 0.28 | 0.13 | 0.015 | 0.001 | 0.11 | 10.1 | 20.9 | 2.03 | — | — | 0.08 | 0.030 | 0.60 |

Furthermore, both sides of the material plate were passivated, whereby firm oxide films were formed on the surface of parent metal. For passivation, the material plate was degreased and cleaned in acetone for 10 minutes, and immersed for 10 minutes in 50 wt % nitric acid bath controlled at 50° C. After passivation, the material plate was washed by water in ordinary temperature twice for 10 minutes each time, and was dried. Subsequently, the both sides of the material plate were plated with silver. For silver plating, the material plate was immersed in a plating bath (pH 11) made by silver cyanide (30 g/L), potassium carbonate (45 g/L), potassium fluoride (30 g/L), and potassium cyanide (20 g/L) held at 25° C. with a current density set at 1.2 A/dm². In this case, the immersion time was set in six periods, that is, 1, 2, 3, 4, 7, and 10 minutes, and the silver amount per unit area increased as the immersion time was increased. After silver plating, the material plate was washed by water in ordinary temperature twice for 10 minutes each time, and six types of separators of preferred embodiment 1 were obtained. In each separator of preferred embodiment 1, conductive inclusions protruded at the surface.

### Preferred Embodiment 2

Six types of separators of preferred embodiment 2 were obtained under the same conditions as in preferred embodiment 1 except that copper plating was performed instead of silver plating. In each separator of preferred embodiment 2 also, conductive inclusions protruded at the surface. For copper plating, the material plate was immersed in a plating bath (pH 11) made by copper (I) cyanide (20 g/L), free sodium cyanide (25 g/L), sodium carbonate (20 g/L), potassium hydroxide (0.5 g/L), and Rochelle salt (15 g/L) held at 40° C. with current density set at 0.8 A/dm². In this case, the immersion time was set in six periods, that is, 1, 2, 3, 4, 7, and 10 minutes, and the copper amount per unit area increased as the immersion time was increased. After copper plating, the material plate was washed by water in ordinary temperature twice for 10 minutes each time.

### Preferred Embodiment 3

Six types of separators of preferred embodiment 3 were obtained under the same conditions as in preferred embodiment 1 except that nickel plating was performed instead of silver plating. In each separator of preferred embodiment 3 also, conductive inclusions protruded at the surface. For nickel plating, the material plate was immersed in a plating bath (pH 5.5) made by nickel sulfate (250 g/L), nickel chloride (38 g/L), boric acid (30 g/L), cobalt sulfate (12 g/L), and formalin (1.5 g/L) held at 40° C. with current density set at 0.8 A/dm². In this case, the immersion time was set in six periods, that is, 1, 2, 3, 4, 7, and 10 minutes, and the nickel amount per unit area increased as the immersion time was increased. After nickel plating, the material plate was washed by water in ordinary temperature twice for 10 minutes each time.

### Preferred Embodiment 4

Six types of separators of preferred embodiment 4 were obtained under the same conditions as in preferred embodiment 1 except that tin plating was performed instead of silver plating. In each separator of preferred embodiment 4 also, conductive inclusions protruded at the surface. For tin plating, the material plate was immersed in a plating bath (pH 11) made by potassium stannate (120 g/L), tin (40 g/L), potassium hydroxide (10 g/L), potassium acetate (5 g/L), and hydrogen peroxide solution (2 g/L) held at 65° C. with current density set at 1.8 A/dm². In this case, the immersion time was set in six periods, that is, 1, 2, 3, 4, 7, and 10 minutes, and the tin amount per unit area increased as the immersion time was increased. After tin plating, the material plate was washed by water in ordinary temperature twice for 10 minutes each time.

### Preferred Embodiment 5

Six types of separators of preferred embodiment 5 were obtained under the same conditions as in preferred embodiment 1 except that platinum plating was performed instead of silver plating. In each separator of preferred embodiment 5 also, conductive inclusions protruded at the surface. For platinum plating, the material plate was immersed in a plating bath (pH 7) made by platinum chloride acid (4 g/L), ammonium phosphate (20 g/L), and sodium phosphate (100 g/L) held at 70° C. with current density set at 1 A/dm². In this case, the immersion time was set in six periods, that is, 1, 2, 3, 4, 7, and 10 minutes, and the platinum amount per unit area increased as the immersion time was increased. After platinum plating, the material plate was washed by water in ordinary temperature twice for 10 minutes each time.

### Preferred Embodiment 6

Six types of separators of preferred embodiment 6 were obtained under the same conditions as in preferred embodiment 1 except that palladium plating was performed instead of silver plating. In each separator of preferred embodiment 6 also, conductive inclusions protruded at the surface. For palladium plating, the material plate was immersed in a plating bath (pH 9) made by palladium diamino nitrite (4 g/L), ammonium nitrate (100 g/L), and sodium nitrite (10 g/L) held at 40° C. with current density set at 0.4 A/dm². In this case, the immersion time was set in six periods, that is, 1, 2, 3, 4, 7, and 10 minutes, and the palladium amount per unit area increased as the immersion time was increased. After palladium plating, the material plate was washed by water in ordinary temperature twice for 10 minutes each time.

### Comparative Example 1

Separators of comparative example 1 were obtained under the same conditions as in preferred embodiment 1 except that silver plating was not performed.

### Comparative Example 2

Six types of separators of comparative example 2 were obtained under the same conditions as in preferred embodiment 1 except the following processes. That is, in the comparative example 2, SUS316L without protruding conductive inclusions on the surface was used as the material. The passivation was replaced by a process of degreasing and cleaning the material plate in acetone for 10 minutes, and immersing the material plate in 10% hydrochloric acid solution for 10 minutes to remove oxide film from the surface. Gold plating was performed instead of silver plating. For gold plating, the material plate was immersed in a plating bath made by gold cyanide (3 g/L) held at 30° C. with current density set at 0.1 A/dm². In this case, the immersion time was set in six periods, that is, 1, 2, 3, 4, 7, and 10 minutes, and the gold amount per unit area increased as the immersion time was increased. After gold plating, the material plate was washed by water in ordinary temperature twice for 10 minutes each time, whereby six types of separators of comparative example 2 were obtained.

B. Observation of Surface

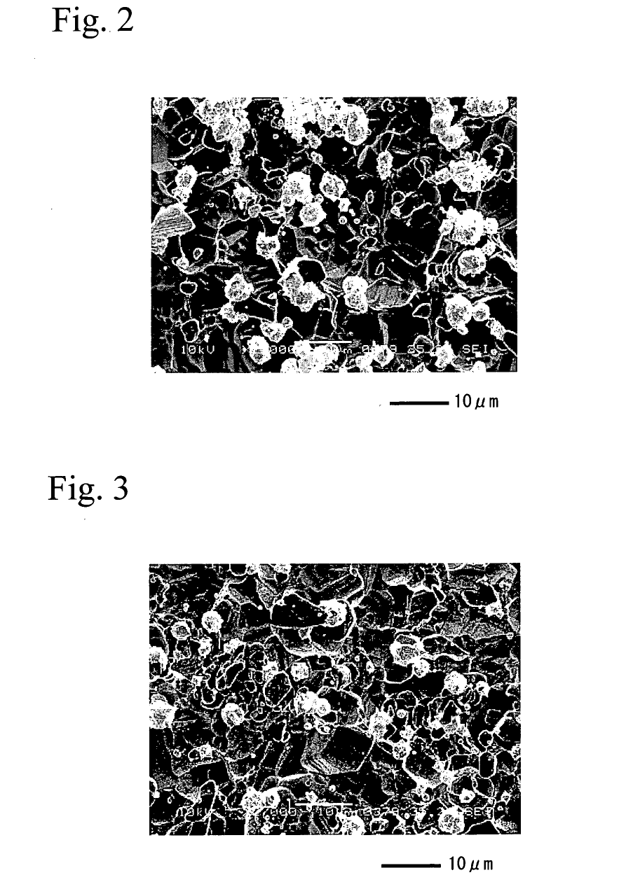

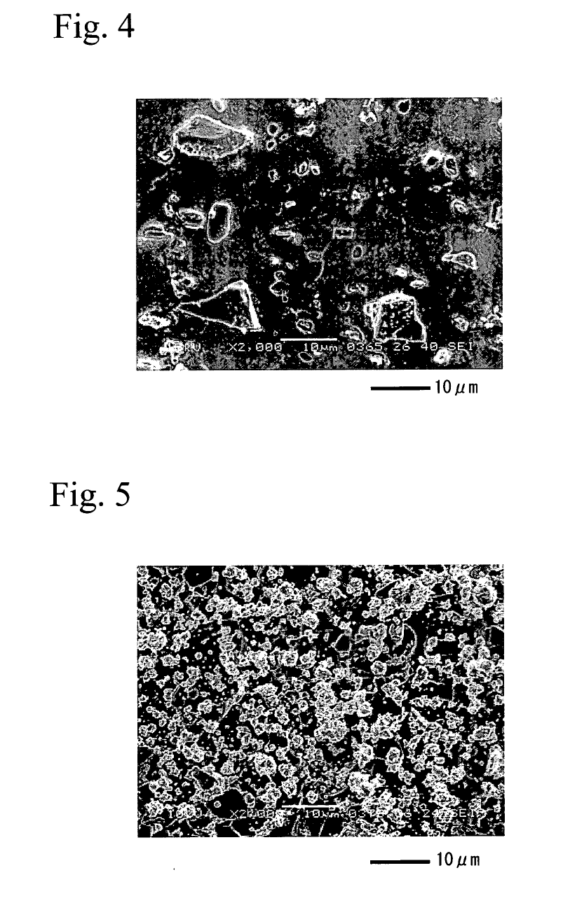

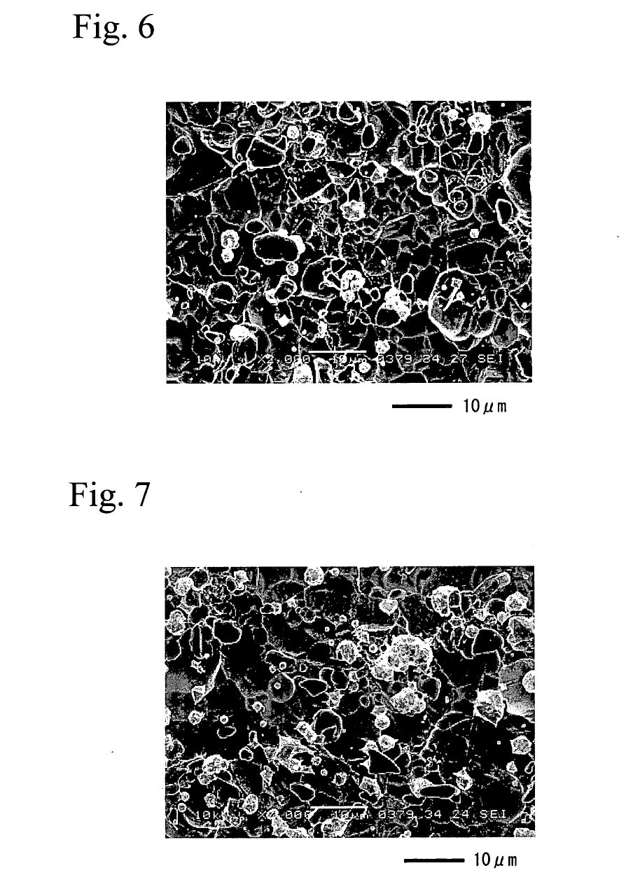

Of six types of separators in preferred embodiments 1 to 6, the surface of samples of which plating time was 10 minutes was observed by an electron microscope. FIG. 2 to FIG. 7 are SEM images thereof, and it is known that granular metal particles were predominantly precipitated on the conductive inclusions dispersed and protruding on the surface of the parent material.

C. Measurement of Gold Amount Per Unit Area

In separators of six types each in preferred embodiments 1 to 6 and comparative example 2, the amount of plating metal per unit area was measured as follows. The separators in preferred embodiments 1 to 6 and comparative example 2 were dissolved in aqua regia, and the amount of gold contained in the solution was quantitatively determined by using an inductively-coupled plasma emission spectrophotometer (model SPS-4000 of Seiko Instruments inc.), and the amount of gold per unit area was calculated from this value (the amount of gold).

D. Measurement of Initial Contact Resistance

In separators of six types each in preferred embodiments 1 to 6 and comparative example 2, and separators in comparative example 1, the initial contact resistance was measured as follows. The carbon sheet which composes the surface of gas diffusion layer of electrode assembly was enclosed by two separators. The integrated member (the carbon sheet and two separators) was further enclosed by two electrode plates. A load was applied so that the surface pressure of the separators on the electrode plates was 5 kg/cm², and test pieces were set in place. By applying current between the two electrode plates, the contact resistance was determined from the voltage drop between separators.

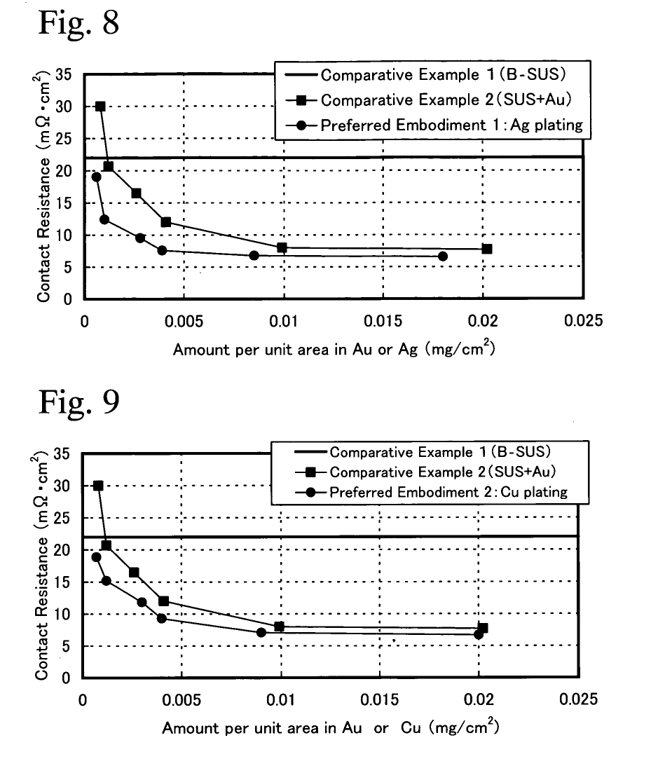

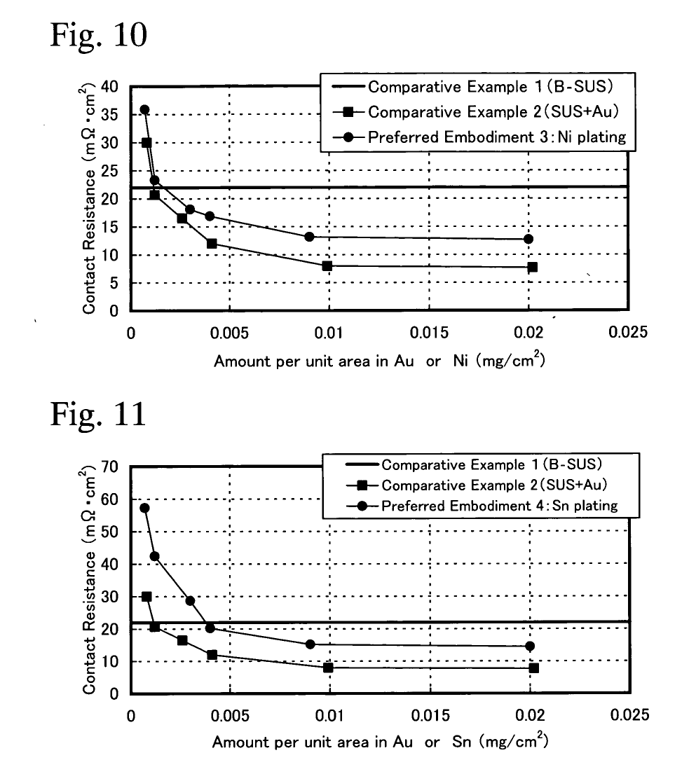

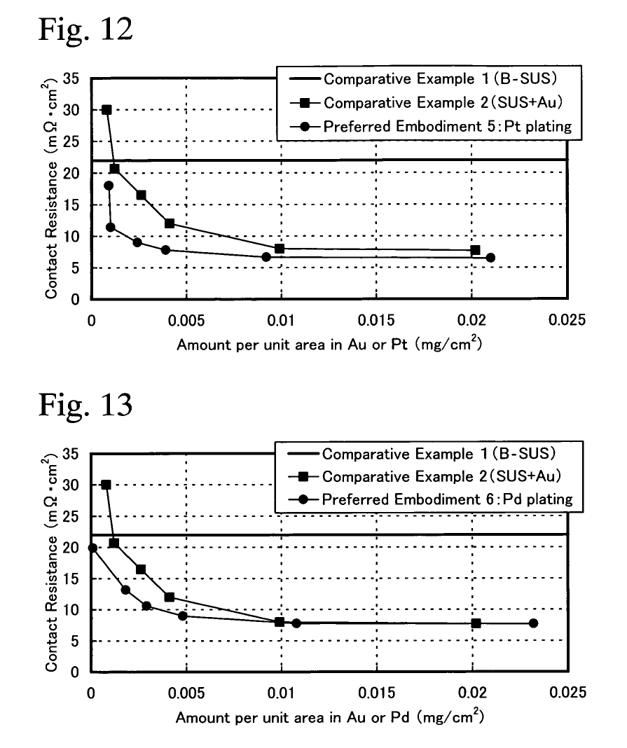

FIG. 8 to FIG. 13 are graphs showing the relationship of plating metal amount per unit area and initial contact resistance measured above. Except for the cases of nickel plating and tin plating (preferred embodiments 3 and 4), when the plating metal amount is the same as the gold plating amount in comparative example 2, it is known that the contact resistance is lower in the separators of preferred embodiments 1, 2, 5, and 6. Further, as long as the plating metal amount per unit area is maintained at 0.0026 mg/cm², it was found that the contact resistance could be decreased substantially. In preferred embodiments 3 and 4, the contact resistance was higher than in comparative example 2, but it was within a sufficiently allowable range, and the cost reducing effect outweighing this disadvantage was confirmed. The difference in contact resistance is evident between comparative example 1 not being plated (B-SUS) and preferred embodiments 1 to 6.

E. Measurement of Contact Resistance After Long Period of Current Supply

By using separators in preferred embodiment 1 in which the silver amount per unit area was 0.018 mg/cm², preferred embodiment 2 in which copper amount per unit area was 0.020 mg/cm², and comparative example 1, test pieces were set by controlling the surface pressure of the separator on the electrode plate at 5 kg/cm², and the contact resistances in the initial period and after current supply for 1000 hours were measured in the same manner above mentioned. Results are shown in Table 2.

TABLE 2
Contact resistance (mΩ · cm²)

| | Preferred | Preferred | Comparative |
|---|---|---|---|
| | Embodiment 1 | Embodiment 2 | Example 1 |
| Initial period | 6.66 | 7.76 | 22 |
| After current | 7.51 | 9.86 | 45 |
| supply | | | |

As is clear from Table 2, in the separators of preferred embodiments 1 and 2, the contact resistance was hardly increased after current supply for 1000 hours, but in the separators of comparative example 1, the contact resistance was increased after current supply for 1000 hours. This is because, in the separators of comparative example 1, plating was not performed while conductive inclusions protruded from the surface, and the surface of the electrode assembly was damaged.

F. Measurement of Cell Voltage

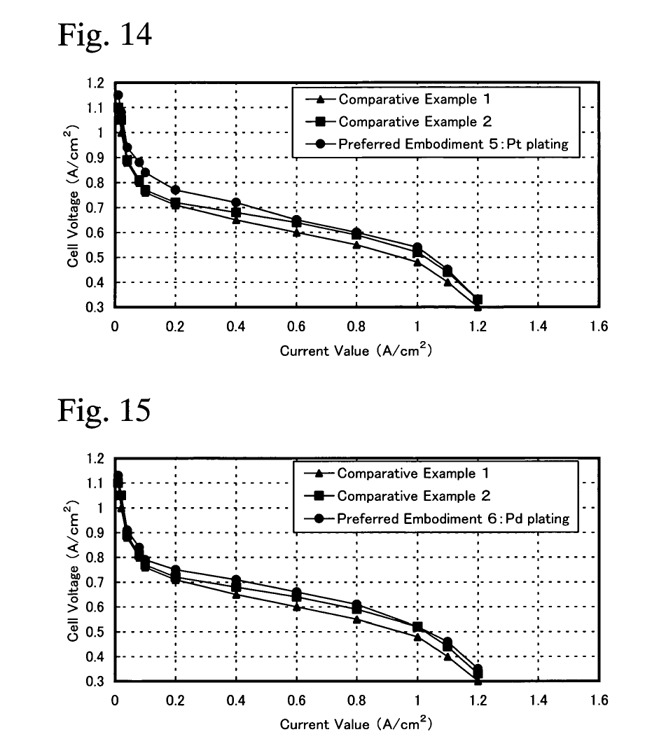

Power generation tests were conducted by assembling fuel cells by using separators in preferred embodiment 5 in which the platinum amount per unit area was 0.0092 mg/cm², preferred embodiment 6 in which palladium amount per unit area was 0.0108 mg/cm², and comparative example 2 in which gold amount per unit area was 0.0202 mg/cm² and comparative example 1 in which no plating is performed. The relationship between current value and cell voltage in power generation is shown in FIG. 14 and FIG. 15.

As shown in FIG. 14 and FIG. 15, in the fuel cells using separators of preferred embodiments 14 and 15, the cell voltage in relation to the current value was higher than that in comparative examples 1 and 2. Considering these results, it has been confirmed that the separator of the invention is superior in power generation performance.

1. A metallic separator for a fuel cell, comprising conductive inclusions exposed on a surface with corrosion resistance,
wherein at least one kind of metal or an alloy thereof selected from silver, copper, nickel and tin selectively on the exposed conductive inclusions is precipitated.

2. A metallic separator for a fuel cell, comprising conductive inclusions exposed on a surface with corrosion resistance,
wherein at least one kind of platinum and palladium selectively on the exposed conductive inclusions is precipitated.

3. A metallic separator for a fuel cell, comprising conductive inclusions exposed on a surface with corrosion resistance,
wherein at least one kind of metal or an alloy thereof selected from silver, copper, nickel and tin selectively on the exposed conductive inclusions is precipitated, and
wherein at least one kind of platinum and palladium selectively on the exposed conductive inclusions is precipitated.

4. The metallic separator for a fuel cell according to claim 1, the conductive inclusions protrude at the surface.

5. The metallic separator for a fuel cell according to claim 2, the conductive inclusions protrude at the surface.

6. The metallic separator for a fuel cell according to claim 3, the conductive inclusions protrude at the surface.

7. A manufacturing method for a metallic separator for a fuel cell, comprising:
preparing a material plate in which conductive inclusions are exposed from a surface with corrosion resistance, and
directly plating a surface of the plate with at least one kind of metal or an alloy thereof selected from silver, copper, nickel and tin, or at least one kind of platinum and palladium, without a treatment for a substrate.

8. A manufacturing method for a metallic separator for a fuel cell, comprising:
preparing a material plate in which conductive inclusions are exposed from a surface with corrosion resistance, and
directly plating a surface of the plate with at least one kind of metal or an alloy thereof selected from silver, copper, nickel and tin, and at least one kind of platinum and palladium without a treatment for a substrate.
